(19) United States
(12) Patent Application Publication
(10) Pub. No.: US 2006/0054167 A1
(43) Pub. Date: Mar. 16, 2006

(54) Regulator assembly particularly for tanks for scuba divers

(75) Inventors: Giovanni Garofalo, Rapallo (IT); Gabriele Canella, Rapallo (IT)

Correspondence Address: MODIANO & ASSOCIATI, Via Meravigli, 16, Milan, 20123, IT

(73) Assignee: HTM SPORT S.p.A.

(21) Appl. No.: 11/222,834

(22) Filed: Sep. 12, 2005

(30) Foreign Application Priority Data
Sep. 16, 2004 (IT) MI2004A001765

(51) Int. Cl. A62B 7/04; A62B 18/10

(52) U.S. Cl. 128/204.26; 128/201.28; 128/201.27

(57) ABSTRACT

A regulator assembly particularly for tanks for scuba divers, comprising a first pressure reduction stage, which can be connected to a tank of compressed air connected, by means of a hose, to a second pressure reduction stage associated with a front regulator. The assembly comprises, at the connection between the hose and the front regulator, a first L-shaped connector for arranging the hose laterally adjacent to the face of the user of the tank. The hose is arranged proximate to the upper region of a shoulder of the user with the tank arranged at the back of the user.

The present invention relates to a regulator assembly particularly for tanks for scuba divers.

### BACKGROUND OF THE INVENTION

As is known, traditionally, the hose that connects the front regulator to the first pressure reduction stage connected to a pressurized air tank is arranged laterally with respect to the axis of the front regulator and forms a broad loop around the head of the user in order to connect to the first pressure reduction stage or otherwise to the tank.

This type of connection causes considerable problems, since the presence of a very large loop produces a region which can constitute an undue catching portion for the hose, especially if the scuba diver is moving in tight spaces and the like.

Another drawback further consits in that the very large loop produces considerable fluid drag, which further increases the jaw effort needed to retain the mouthpiece, which is already considerable due to the presence of a very long hose.

Another problem further consists in that the presence of a very large loop in the hose for connecting the front regulator entails the use of a long hose, which causes considerable difficulties in retrieving the regulator when it is disengaged from the mouth, since the regulator tends to arrange itself downwardly behind the back, making it difficult to retrieve.

Solutions have already been studied in order to try to solve these problems; thus, for example, patent application EP 0 945 339 provides a solution in which a jacket is formed in which the hose for connecting the front regulator in practice is arranged in a pouch formed in the front lower part, thus assuredly solving the problem of the possibility of catching and of fluid drag for the hose, and further making it considerably easier to retrieve the regulator when it is disengaged from the mouth, but without solving completely the problem of jaw effort.

Other known solutions provide a hose which is connected to the front regulator by means of a rotatable L-shaped connector, so that the hose assumes a looped shape, passing below the arm, substantially at the armpit region, thus allowing to eliminate assuredly the problems linked to hose catching and fluid drag but without solving the problem of jaw effort, which is certainly intense, and making it very difficult to retrieve the regulator when it is disengaged from the mouth; moreover, the presence of a very long hose causes considerable load losses.

### SUMMARY OF THE INVENTION

The aim of the present invention is to eliminate the drawbacks noted above by providing a regulator assembly for tanks for scuba divers that allows to eliminate in practice the possibility of hose catching and fluid drag, further completely solving the problem of jaw effort and of easy retrieval of the regulator.

Within this aim, an object of the invention is to provide a regulator assembly which is particularly compact and functional, thus allowing to provide a shorter hose without thereby limiting in any way the freedom of movement of the head of the user.

Another object of the present invention is to provide a regulator assembly which thanks to its particular constructive characteristics is capable of giving the greatest assurances of reliability and safety in use.

Another object of the present invention is to provide a regulator assembly which can be easily obtained starting from commonly commercially available elements and materials and is further competitive from a merely economical standpoint.

This aim and these and other objects, which will become better apparent hereinafter, are achieved by a regulator assembly particularly for tanks for scuba divers, according to the invention, which comprises a first pressure reduction stage, which can be connected to a tank of compressed air and is connected, by means of a hose, to a second pressure reduction stage which is associated with a front regulator, characterized in that it comprises, at the connection between said hose and said front regulator, a first L-shaped connector for arranging said hose laterally adjacent to the face of the user of said tank, said hose being arranged proximate to the upper region of a shoulder of said user with said tank arranged at the back of said user.

### BRIEF DESCRIPTION OF THE DRAWINGS

Further characteristics and advantages of the present invention will become better apparent from the description of a preferred but not exclusive embodiment of a regulator assembly particularly for tanks for scuba divers, illustrated by way of non-limiting example in the accompanying drawings, wherein:

FIG. 1 is a view of a first embodiment of the regulator assembly with the hose connected to the tank by means of a loop;

FIG. 2 is a view of the regulator assembly with a hose having a simple loop, according to the invention, schematically integrated in a jacket or vest;

FIG. 3 is a view of the regulator assembly with a hose provided with a double loop, schematically integrated in a jacket or vest;

FIG. 4 is a side view of the regulator assembly with a hose connected to the first reduction stage and to the front regulator by means of rotary connectors;

FIG. 5 is a top plan view of the embodiment of FIG. 3;

FIG. 6 is a view of a third embodiment, with the hose connected to the first stage with a rotary connector arranged in the lower part;

FIG. 7 illustrates an embodiment with a hood for supporting the hose;

FIG. 8 is a side elevation view of the connection of the hose to a helmet;

FIG. 9 is a rear elevation view of the connection of the hose to the helmet;

FIG. 10 is a side elevation view of the connection of the hose to a frame;

FIG. 11 is a rear elevation view of the connection of the hose to a frame.

### DESCRIPTION OF THE PREFERRED EMBODIMENTS

With reference to the figures, the regulator assembly particularly for tanks for scuba divers, generally designated by the reference numeral 1, comprises a first pressure reduction stage 2, which in a per se known manner is connected to a tank 3 of pressurized air.

The first pressure reduction stage is connected by means of a hose 4 to a second pressure reduction stage, which is associated with a front regulator, generally designated by the reference numeral 5, which in a per se known manner is connected to a usual mouthpiece 6.

The peculiarity of the invention consists in that at the region for connecting the hose 4 to the front regulator 5 there is a first L-shaped connector 10, which is structured so that the hose 4 arranges itself laterally to the face of the user of the tank 3.

The first L-shaped connector 10 can be of a fixed type but is preferably of the rotary type, allowing the end of the hose 4 to oscillate about an axis, designated by the reference numeral 11, which is arranged laterally and substantially at right angles with respect to the central axis of the front regulator.

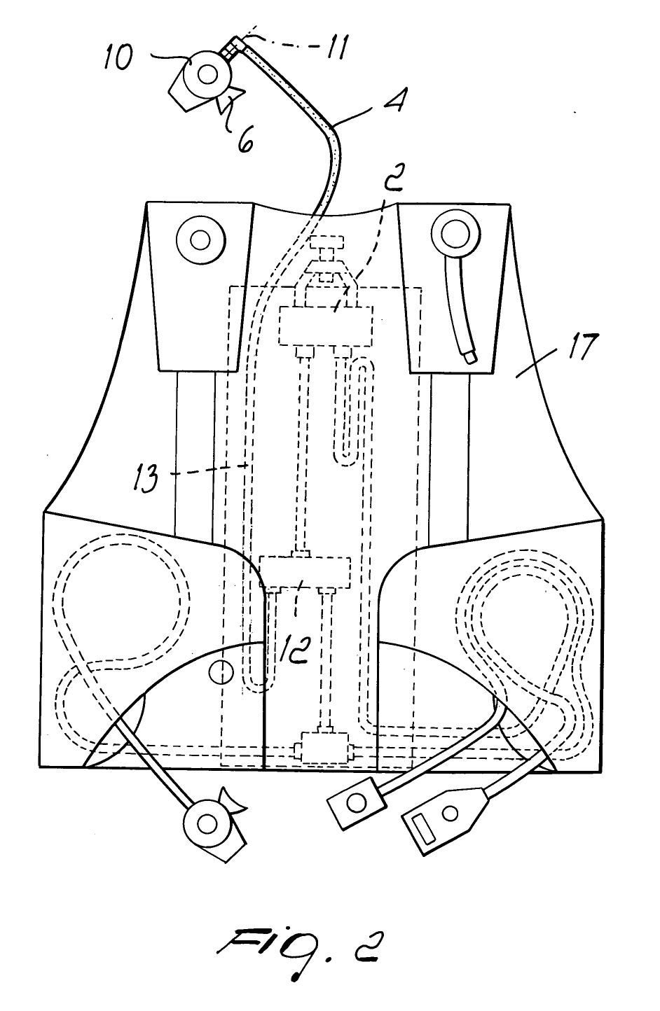

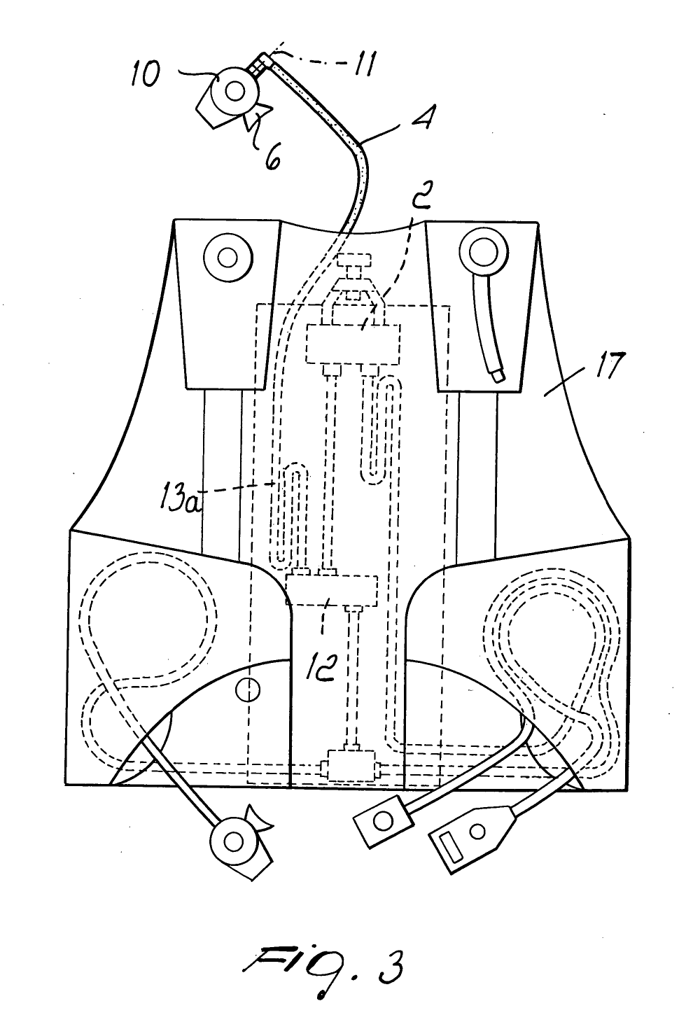

According to FIG. 2, at the other end the hose 4 is connected to an air diverter or distributor 12 by interposing, on the hose 4, a simple loop, generally designated by the reference numeral 13, whereas in FIG. 3 the hose forms a double loop 13a; the loops are meant to allow to take up the loop so as to allow movements of the head of the user; it is of course possible to vary at will the type of loops as well as the type of connection.

An important characteristic of the invention consists in that the hose 4 lies proximate to the upper region of a shoulder of the user, with the tank arranged at the back of said user.

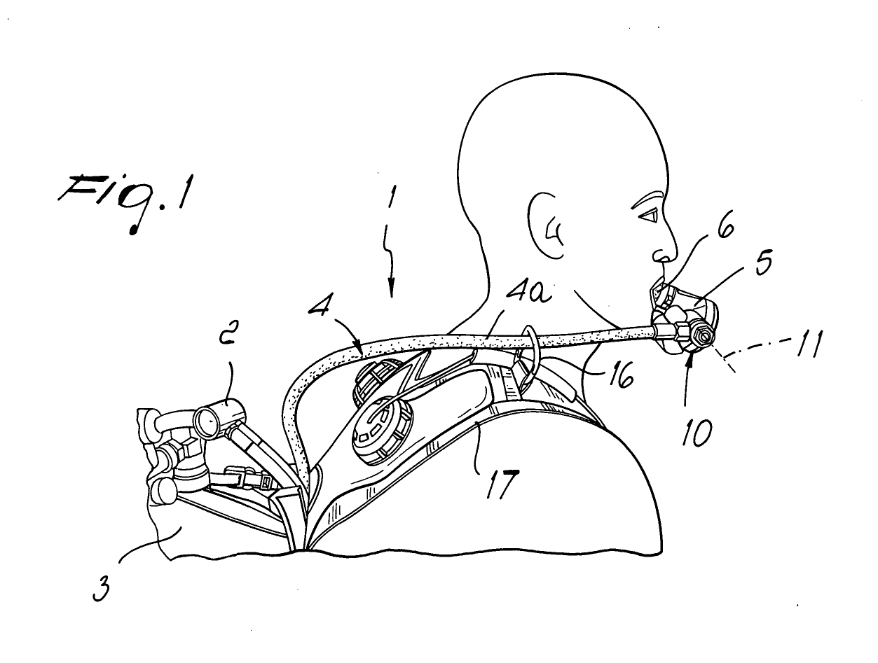

As illustrated schematically in FIG. 1, the hose 4 passes proximate to the shoulder on the side where the connector 10 is connected to the front regulator 5.

Advantageously, the hose 4 engages a ring 16, which can be of the openable type and is for example applied at a vest 17 worn by the user.

With this type of arrangement, therefore, a hose is provided which does not allow catching, since it does not form a large loop at the head of the user and accordingly does not have a substantial fluid drag.

Moreover, with the arrangement described above it is particularly easy to retrieve the front regulator when it is disengaged from the mouth, since it remains arranged at the shoulder.

Considerable advantages are also obtained as regards jaw fatigue, since the free portion of the hose that might act on the regulator, consequently causing jaw effort, is reduced.

According to another embodiment, it is possible to provide at the first pressure reduction unit 2 a second connector, preferably of the rotary type 20, for the connection of the hose 4, which accordingly arranges itself, with its initial portion, laterally adjacent to the face of the user and forms a small loop, designated by the reference numeral 4a, at the rear part of the nape of the neck, so as to allow the free movement of the head.

The presence of first and second L-shaped rotary connectors allows to adapt the position of the hose without causing negative repercussion as regards jaw effort.

Moreover, it is possible to use a very short portion of hose, consequently reducing all the load losses that might occur.

The first connector 20 can be fitted so that it can oscillate about a substantially vertical axis 21 and can be arranged above the first pressure reduction unit 2.

Advantageously, a retention element 22 is provided which delimits the oscillation of the end of the hose, so as to form a loop which lies predominantly opposite the side that is laterally adjacent to the face of the user.

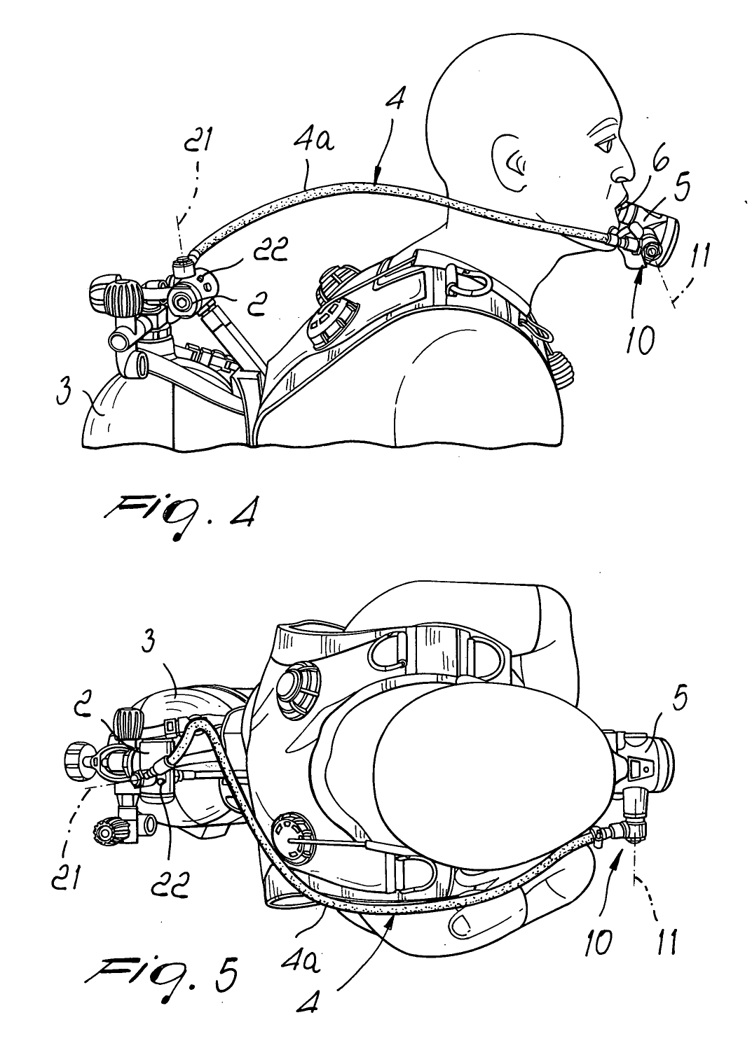

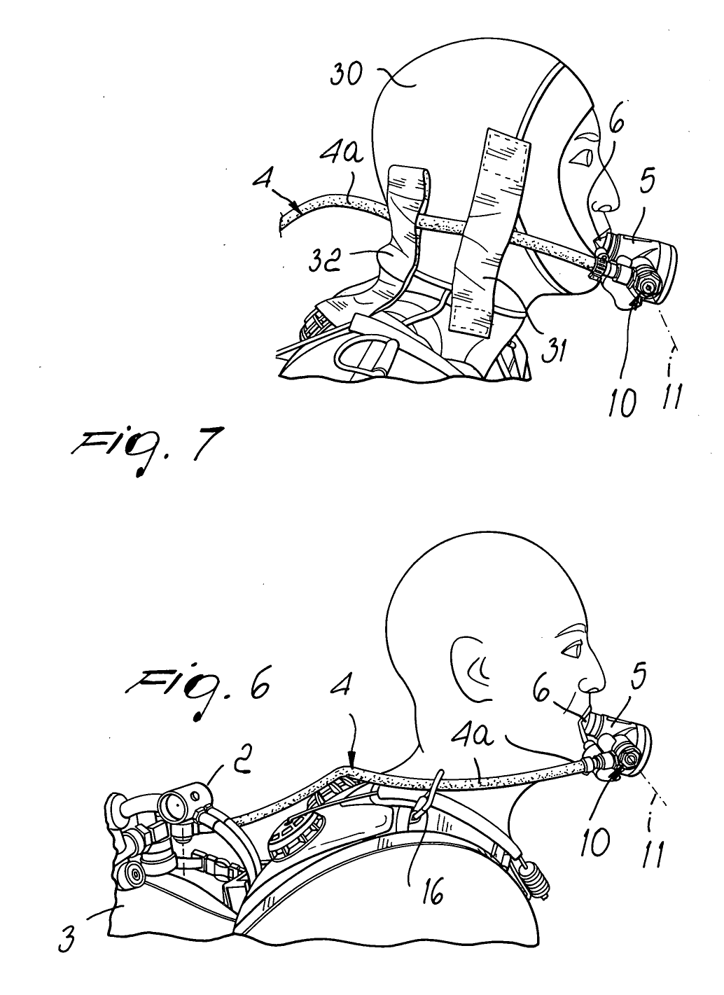

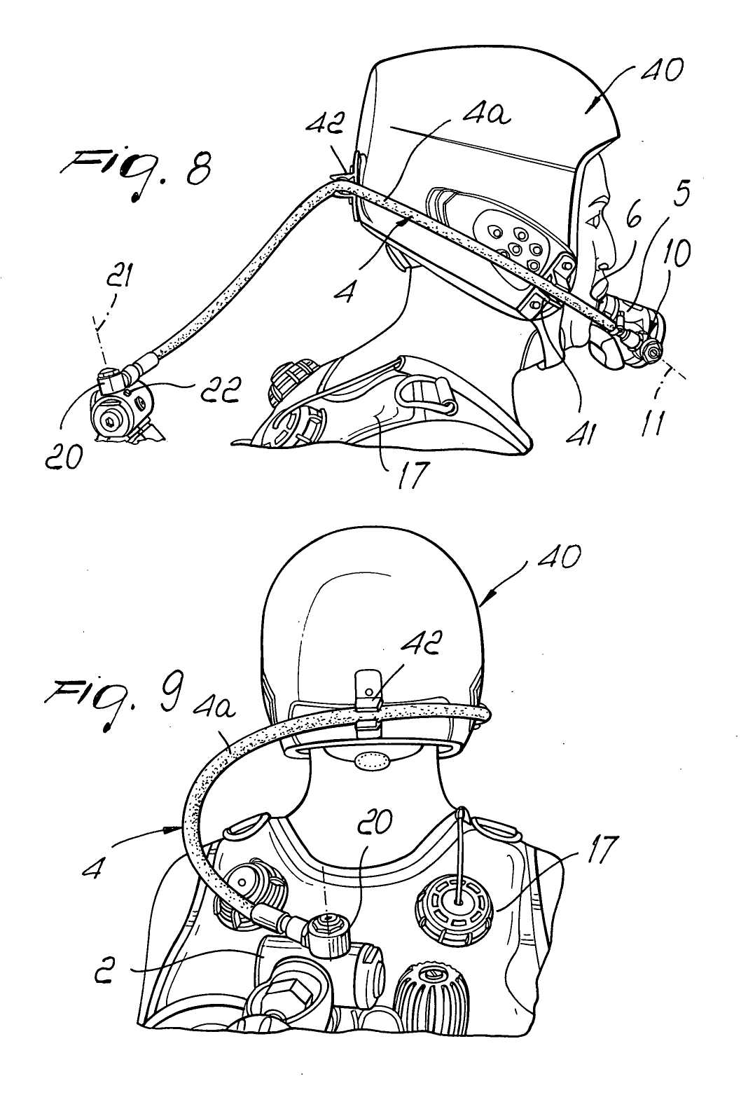

According to FIG. 5, the second L-shaped connector, again designated by the reference numeral 20, can be connected downwardly with respect to the first pressure reduction unit and can thus move the hose closer to the body of the user.

In order to further increase the reduction of jaw effort, it is possible to provide an accessory which in practice comprises a body which can be coupled detachably to the head of a scuba diver; this body, as illustrated in FIG. 6, is constituted for example by a hood 30, which is worn by the scuba diver and is provided laterally with means for engaging the hose 4.

Said means must be certainly provided at the cheek and in the embodiment illustrated in FIG. 6 are constituted by a lateral ring 31, which forms a bridge which retains the hose proximate to the first L-shaped connector 10, consequently reducing the free portion of the hose, so that in practice jaw effort is eliminated completely, as the front regulator in practice is supported by the hood.

It is further possible to provide a rear loop 32 for the hose which improves the fixing of the hose to the head of the user.

In order to increase the stability of the connection of the hose to the head of the user, it is possible to provide the body as a helmet 40 in which the means for engaging the hose are constituted by a lateral clip 41, which is arranged at the cheek and in which it is possible to insert the hose 4, and optionally by a rear clip 42, which in practice provides a portion of hose which is supported by the helmet and lies laterally adjacent to said helmet for a certain extent.

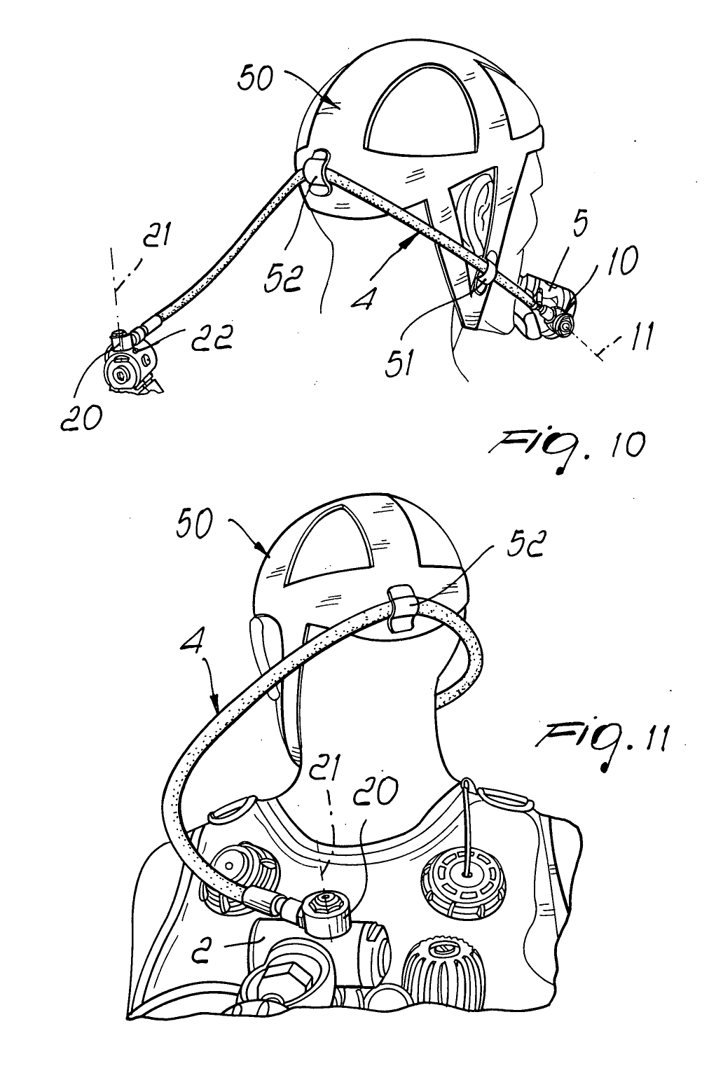

As illustrated in FIGS. 10 and 11, it is possible to provide a frame 50, which can be fitted over the head of the user and supports means for engaging the hose, which are constituted by a lateral ring 51 and by a rear ring 52, which support the portion of hose in the end region that lies proximate to the mouth of the user.

In these solutions, therefore, the free portion of hose at the connection to the regulator is particular reduced, and therefore any stresses cannot be transmitted to the front regulator 5, so that in practice jaw effort is eliminated completely.

In this case also, it is possible to use a hose in which the connectors for connection to the first pressure reduction stage and to the front regulator can rotate about the previously mentioned axes; however, it is also conceptually possible to use fixed connectors, albeit with less advantageous results.

Moreover, it must be specified that the hose can be arranged laterally adjacent to the face of the user either to the right or to the left, depending on personal preferences, and the arrangement of the small loop formed at the rear part of the nape of the neck of the user is of course reversed correspondingly.

From what has been described above it is therefore evident that the invention achieves the proposed aim and objects, and in particular the fact is stressed that a regulator assembly is provided in which it is possible to support adequately the hose for connection of the front regulator, eliminating the large loop that was present laterally to the face of user and further achieving a drastic reduction, and even total elimination, of jaw effort.

The problem of retrieving the regulator when released is also easily solved, since it always remains located proximate to the face of the user.

The invention thus conceived is susceptible of numerous modifications and variations, all of which are within the scope of the appended claims.

All the details may further be replaced with other technically equivalent elements.

In practice, the materials used, so long as they are compatible with the specific use, as well as the contingent shapes and dimensions, may be any according to requirements.

The disclosures in Italian Patent Application No. MI2004A001765 from which this application claims priority are incorporated herein by reference.

What is claimed is:

1. A regulator assembly particularly for tanks for scuba divers, comprising a first pressure reduction stage, which can be connected to a tank of compressed air and is connected, by means of a hose, to a second pressure reduction stage associated with a front regulator, further comprising, at a connection between said hose and said front regulator, a first L-shaped connector for arranging said hose laterally adjacent to the face of a user of said tank, said hose being arranged proximate to an upper region of a shoulder of said user with said tank arranged at the back of said user.

2. The regulator assembly according to claim 1, wherein said first L-shaped connector can rotate so that it can oscillate about an axis which lies laterally and substantially at right angles with respect to a central axis of said front regulator.

3. The regulator assembly according to claim 1, wherein said hose has a double loop for taking up the hose in a portion for connection to said first pressure reduction unit.

4. The regulator assembly according to claim 3, wherein said loop for taking up the hose is a simple loop.

5. The regulator assembly according to claim 3, wherein said loop for taking up the hose is a double loop.

6. The regulator assembly according to claim 1, further comprising, at an end of said hose that lies opposite the end for connection to said front regulator, a second L-shaped connector for connection to said first pressure reduction unit.

7. The regulator assembly according to claim 6, wherein said second L-shaped connector can rotate about an axis which is substantially parallel to the longitudinal axis of said tank.

8. The regulator assembly according to claim 1, further comprising a ring which is arranged at said shoulder of the user and can be engaged detachably with said hose.

9. The regulator assembly according to claim 6, wherein said second L-shaped connector is connected in an upward region with respect to said first pressure reduction stage.

10. The regulator assembly according to claim 6, wherein said second L-shaped connector is connected in a downward region with respect to said pressure reduction unit.

11. The regulator assembly according to claim 6, wherein said hose, in a portion comprised between said first and second L-shaped connectors, forms a small loop, which lies at the opposite side with respect to the part where said first L-shaped connector is positioned.

12. The regulator assembly according to claim 6, wherein said hose, in a portion comprised between said first and second L-shaped connectors, forms a single loop, which lies on a part where said first L-shaped connector is positioned.

13. The regulator assembly according to claim 6, further comprising a retention element in order to delimit oscillation of the end of said hose which is connected to said second L-shaped connector.

14. A regulator assembly particularly for tanks for scuba divers, comprising a first pressure reduction stage, which can be connected to a tank of pressurized air and is connected, by means of a hose, to a second pressure reduction stage, which is associated with a front regulator, further comprising an accessory provided with a body which can be coupled detachably to the head of a user and is provided with means for engaging said hose.

15. The regulator assembly according to claim 14, wherein said body is constituted by a hood.

16. The regulator assembly according to claim 14, wherein said body is constituted by a frame.

17. The regulator assembly according to claim 14, wherein said means for engaging the hose comprise at least one lateral ring arranged at the cheek of the user.

18. The regulator assembly according to claim 15, further comprising a rear ring which is connected to said hood proximate to the nape of the neck.

19. The regulator assembly according to claim 14, wherein said body comprises a helmet.

20. The regulator assembly according to claim 14, wherein said means for engaging the hose provide at least one clip arranged at the cheek of the user.

21. The regulator assembly according to claim 14, wherein said hose engagement means comprise a rear clip, which is arranged substantially at the nape of the neck.

22. An accessory for scuba divers, comprising a body which can be coupled detachably to the head of a scuba diver, further comprising, on said body, means for detachable engagement with a connecting hose of a front regulator which is connected to a tank of pressurized air.

23. The accessory according to claim 22, wherein said body comprises a hood.

24. The accessory according to claim 22, wherein said body comprises a frame.

25. The accessory according to claim 22, wherein said means for engaging the hose comprise at least one lateral ring arranged at the cheek of the user.

26. The accessory according to claim 22, wherein said means for engagement with the hose comprise a rear ring which is arranged proximate to the nape of the neck of the user.

27. The accessory according to claim 22, wherein said body is constituted by a helmet.

28. The accessory according to claim 22, wherein said means for engaging the hose comprise a lateral clip arranged on said helmet at the cheek of the user.

29. The accessory according to claim 22, wherein said hose engagement means comprise a rear clip, which is arranged on said helmet at the nape of the neck of the user.
